(19) United States
(12) Patent Application Publication
(10) Pub. No.: US 2013/0300082 A1
(43) Pub. Date: Nov. 14, 2013

(54) PUSH SCOOTER WITH VERTICALLY ACTIVE SUSPENSION

(71) Applicants: Craig Swinney, El Dorado Hills, CA (US); Kameron Swinney, El Dorado Hills, CA (US); Kyle Swinney, El Dorado Hills, CA (US)

(72) Inventors: Craig Swinney, El Dorado Hills, CA (US); Kameron Swinney, El Dorado Hills, CA (US); Kyle Swinney, El Dorado Hills, CA (US)

(21) Appl. No.: 13/308,173

(22) Filed: Nov. 30, 2011

Related U.S. Application Data
(60) Provisional application No. 61/466,230, filed on Mar. 22, 2011.

(51) Int. Cl. B62M 1/10

(52) U.S. Cl. 280/212

(57) ABSTRACT

The invention is a push scooter having a suspension capable of storing significant potential energy. Once the potential energy in the suspension is released, the rider can more easily travel vertically off of the ground and perform acrobatics. In the preferred embodiment, the inventive push scooter has both a front suspension and a rear suspension. The front suspension is comprised of a vertical spring mechanism having significant suspension travel. The rear suspension is preferably comprised of a suspension arm attached to the rear deck of the scooter. The rider can apply downward pressure to the deck, causing the rear suspension to flex downward and store vertical potential energy, with the front suspension following suit. Upon releasing the stored potential energy, the rider is aided in traveling vertically, along with the scooter; and various vertical acrobatics become easier to perform.

### RELATED APPLICATIONS

This patent application claims the benefit of U.S. Provisional Ser. No. 61/466,230, filed on Mar. 21, 2011.

### TECHNICAL FIELD

This invention relates to the field of push scooters, and more specifically, to a suspension for push scooters which aids in propelling the scooter and its rider in a substantially vertical direction.

### BACKGROUND

Some of today's push scooters have suspensions designed to absorb minor road shocks. Most push scooters locate these suspension systems at the front of the scooter to absorb shock being transmitted to the rider through the handle bars. For example, the handle bar stem of the typical push scooter is often a hollow, vertical tube ending in T-shaped handlebars. Inside of the vertical tube is transposed a shock absorbing system which often consists of a spring-loaded shock absorber. Other shock absorbing suspension designs for the front and rear wheels of a push scooter are also evident in the art (See, for example, U.S. Pat. No. 6,406,042 and U.S. Patent Publication No. 2001/0030404).

The push scooter suspension art thus far has been directed at absorbing road shock and has not ventured beyond the shock absorbing function. The present push scooter invention has successfully incorporated the shock absorbing function, but also has the capability to employ its suspension to allow the rider to more easily perform vertical acrobatics.

The foregoing reflects the state of the art of which the inventor is aware, and is tendered with a view toward discharging the inventor's acknowledged duty of candor, which may be pertinent to the patentability of the present invention. It is respectfully stipulated, however, that the foregoing discussion does not teach or render obvious, singly or when considered in combination, the inventor's claimed invention.

### SUMMARY OF THE INVENTION

The invention is a push scooter having a suspension capable of storing significant potential energy for launching the scooter and rider in a vertical direction; once the potential energy in the suspension is released, the rider can more easily travel vertically off of the ground and perform acrobatics while in the air. In the preferred embodiment, the inventive push scooter has both a front suspension and a rear suspension. The front suspension is located in the vertical handle bar tube and is preferably comprised of a spring having a greater amount of suspension travel than other scooters having a spring-loaded handle bar stem. The front suspension travel is preferable around four inches, which is enough to give the allow the front suspension to compress and release in a “pogo-stick” fashion, as well as function in a shock absorbing manner to absorb shock from uneven and off-road surfaces. The rear suspension is preferably comprised of an elongate suspension arm solidly attached to the deck of the scooter. The rear wheel would reside at an opposite end on the arm from the deck, such that the arm is suspended between the wheel and deck. The suspension arm is sprung to a certain tension for allowing a rider to exert downward force on the deck to cause the suspension arm to store vertical potential energy. The elongate suspension arm may be in the form of a leaf spring where one end of the spring attaches to the scooter deck and the other end of the spring attaches to the rear wheel so that a spring-action between the rear wheel and deck is maintained. The rider can apply downward pressure to the deck, causing the rear suspension to flex downward and store vertical potential energy. Upon releasing the stored potential energy, the rider is aided in traveling vertically, along with the scooter; and various vertical acrobatics become easier to perform.

Accordingly, the following objects and advantages of the invention apply:

It is an object of this invention to provide a push scooter having a suspension which stores vertical potential energy, thus making it easier for a rider to perform vertical acrobatics.

It is another object of this invention to provide a push scooter having a suspension which absorbs significant road shock and which can be ridden comfortably on a variety of terrain.

Further objects and advantages of the invention will be brought out in the following portions of the specification, wherein the detailed description is for the purpose of fully disclosing the preferred embodiments of the invention, without placing limitations thereon.

### BRIEF DESCRIPTION OF THE DRAWINGS

The invention will be more fully understood by reference to the following drawings which are for illustrative purposes only:

FIG. 1 is a side perspective view of the inventive push scooter.

FIG. 2 is a left side view of the inventive push scooter showing the steering assembly in cutaway.

FIG. 3 is a right side view of the inventive push scooter.

FIG. 4 is a front view of the inventive push scooter showing the steering assembly in cutaway.

FIG. 5 is a plan view of the inventive push scooter.

FIG. 6 is a bottom view of the inventive push scooter.

FIG. 7 is an illustration of a rider providing downward force upon the inventive scooter (right arrow signifies applied downward force) and causing the front and rear suspensions to store potential energy and subsequently releasing the potential energy stored in the front and rear suspension of the inventive scooter (middle arrow signifies released potential energy) and aiding the scooter and rider to travel vertically, leaving the ground.

FIG. 8 is a side view of an alternate embodiment of the inventive push scooter.

FIG. 9 is a side view of an alternate embodiment of the inventive push scooter having an external spring on the front suspension.

### DETAILED DESCRIPTION OF THE PREFERRED EMBODIMENTS

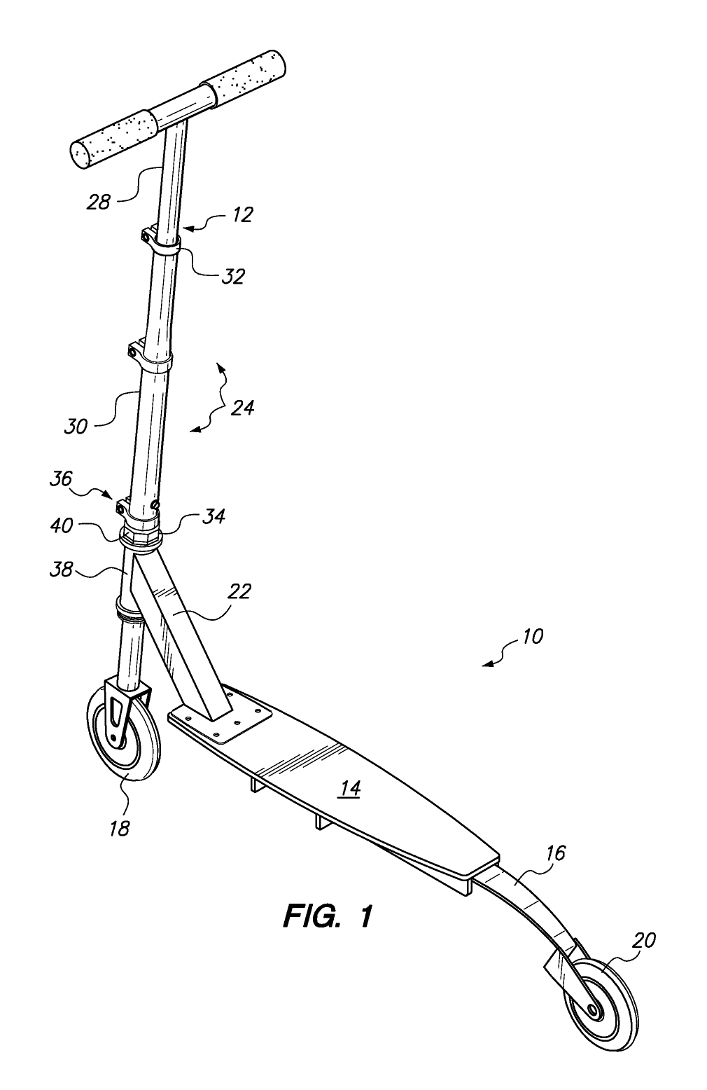

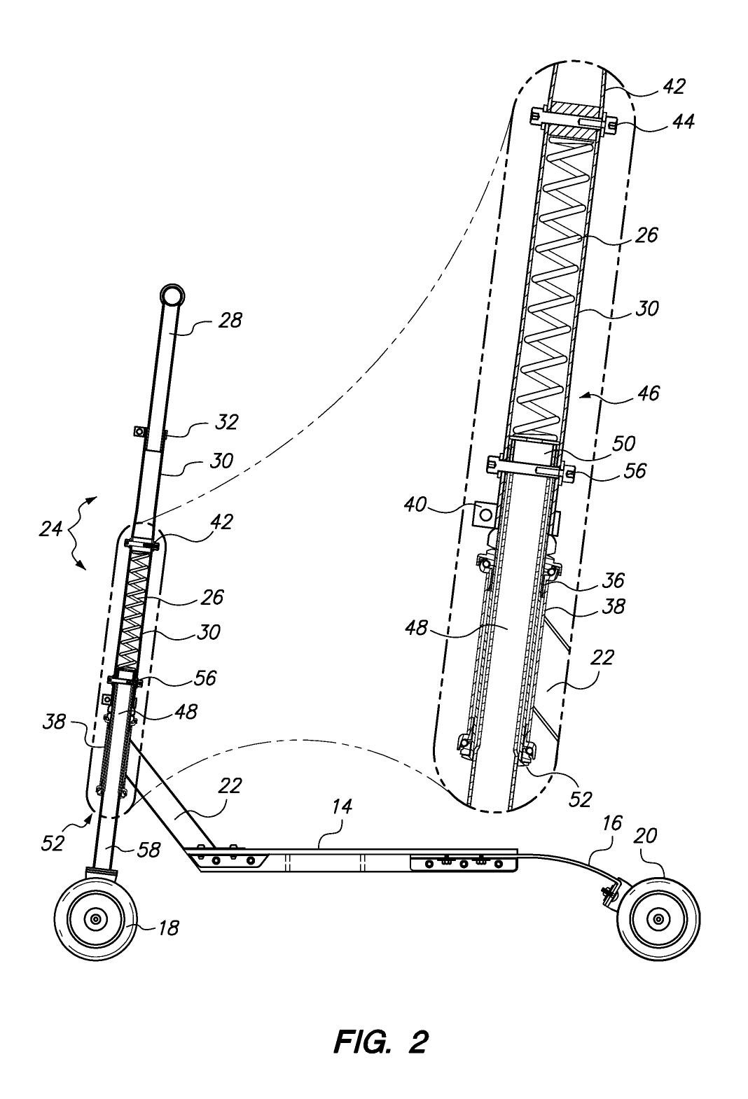

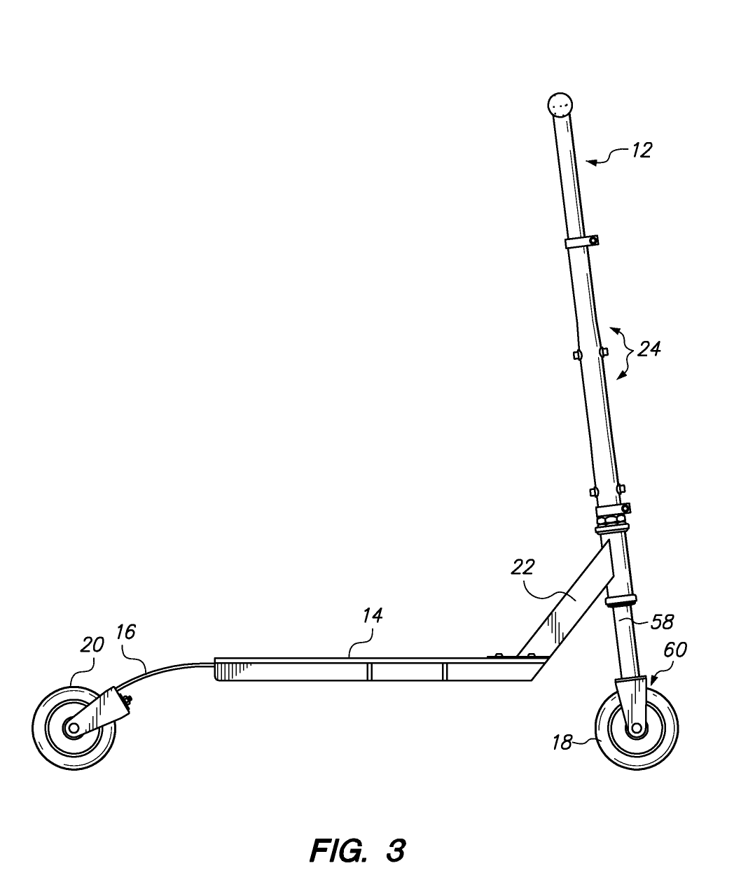

The preferred embodiment of the inventive push scooter 10 is shown in FIG. 1, which illustrates the basic components such as the handle bar 12, deck 14, rear suspension arm 16, wheels 18, 20 and steering assembly support bracket 22. FIGS. 2-3 are side views of the inventive push scooter 10, where FIG. 2 shows the steering assembly components in cutaway.

As shown, the steering assembly 24 functions as a front suspension for the inventive push scooter. In the preferred embodiment, a compression spring (shown) 26 or a hydraulic shock absorber (not shown) would operate to provide shock absorption to the steering assembly 24. Although front shock assemblies have been in vogue for awhile, most of them are not adequate to absorb substantial road shock, mainly because the amount of front suspension travel is an inch or less from the top of the wheel to the bottom of the steering head. This works adequately for a push scooter that is dedicated to travel on paved streets. However, it is wholly inadequate for even mild off-road travel. Ideally, the inventive push scooter 10 employs a steering assembly 24 which is capable of providing approximately four inches of suspension travel. This additional travel allows for adequate shock absorption on a wide variety of terrain. Additionally, this level of suspension travel has utility for storing vertical potential energy shock when a rider performs aerial acrobatics.

The steering assembly 24 is comprised of a handle bar 12, which can be T-shaped as shown, the handle bar has a vertical handle bar tube 28 which is inserted into a shock tube 30. The shock tube 30 extends from top compression clamp 32 to head tube bearing race 34. Shock tube 30 is secured at its bottom end 36 to head tube 38 by bottom compression clamp 40 and shock tube 30 contains the functional shock absorption components. Handle bar tube 28 is of a smaller diameter than shock tube 30 and handle bar tube 28 is inserted into shock tube 30 and retained therein by top compression clamp 32. A retaining plug 42 is located below handle bar tube 28 and serves to retain the top of compression spring 26. Retaining plug 42 is held in place within the shock tube 30 by retaining pin 44. At its bottom end 46, compression spring 26 is connected to the top 50 of front suspension piston 48 which is inserted through the bottom 52 of head tube 38 and extends through head tube 38 into shock tube 30 where it is joined to compression spring 26. Also, compression spring 26 can be made to be adjustable by means familiar in the art. One example would be means applied to adjustable pogo sticks and the like so that the front suspension can act in a similar fashion to a pogo stick. In such a manner the front suspension would store and release vertical potential energy.

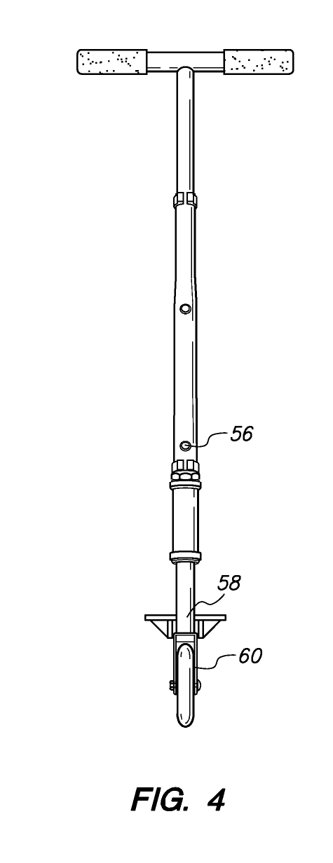

Referring also to FIG. 4, front suspension piston 48 has a slot (not shown) imparted vertically front to back in which is inserted a retaining pin 56. Retaining pin 56 provides a stop to allow the front suspension piston 48 to travel vertically up and down and then stop once retaining pin 56 contacts the top or bottom of the slot. Because the amount of suspension travel in the inventive push scooter 10 is preferably around four inches, the slot in front suspension piston 48 likewise is dimensioned approximately four inches to allow the appropriate range of vertical suspension travel. At the bottom of front suspension piston 58 is connected the front wheel assembly 60.

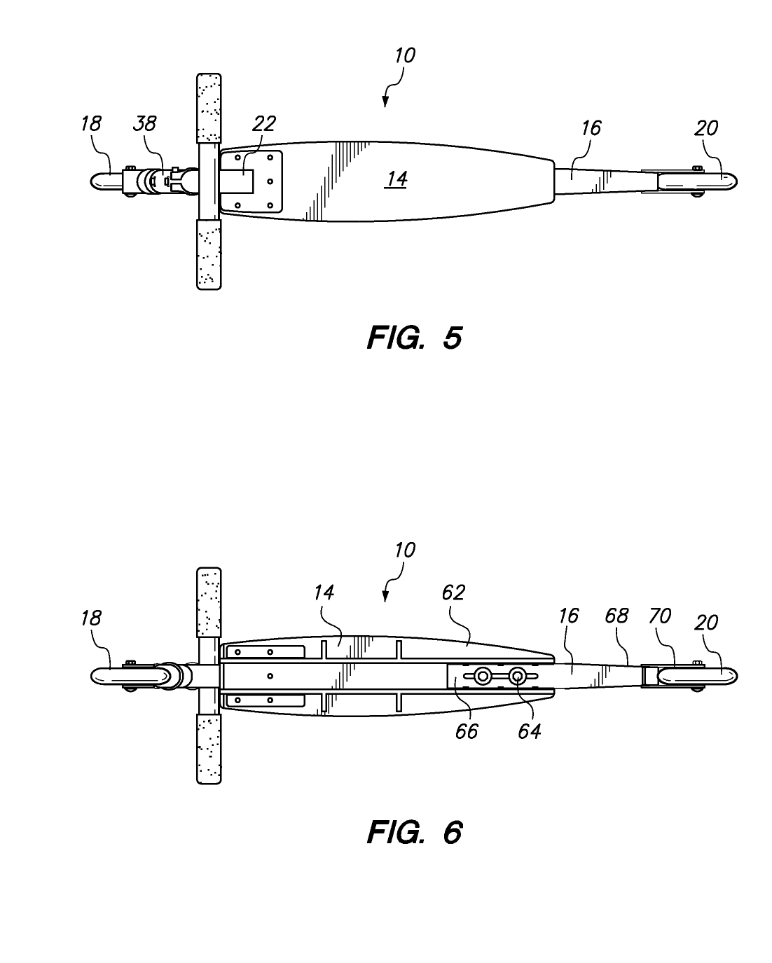

Referring also to FIGS. 5 and 6, the deck 14 of the push scooter 10 is connected to head tube 38 by a support bracket 22. Moving rearward on the deck away from the support bracket 22, the rear suspension arm 16 is shown. In its preferred embodiment, the rear suspension arm 16 attaches at its front 66 to the under-deck 62 via a mounting bracket 64. The rear 68 of the suspension arm 16 is attached to the rear wheel assembly 70 such that the rear wheel 20 floats at the end of the rear suspension arm 16 as the suspension arm flexes and bends. The rear suspension arm 16 flexes downward when downward force is applied and stores potential energy. This stored potential energy can then be released when the rear suspension arm flexes upward during normal suspension functions or can be voluntarily released upward by a rider to aid a rider in launching vertically off of the ground to perform aerial acrobatics. The rear suspension arm 16 must flex and store potential energy when downward force is applied to the deck 14 of the scooter by a rider. It has been found that a generally elongate leaf spring mounted to the deck 14 provides a suspension arm 16 which meets the requirements of the invention.

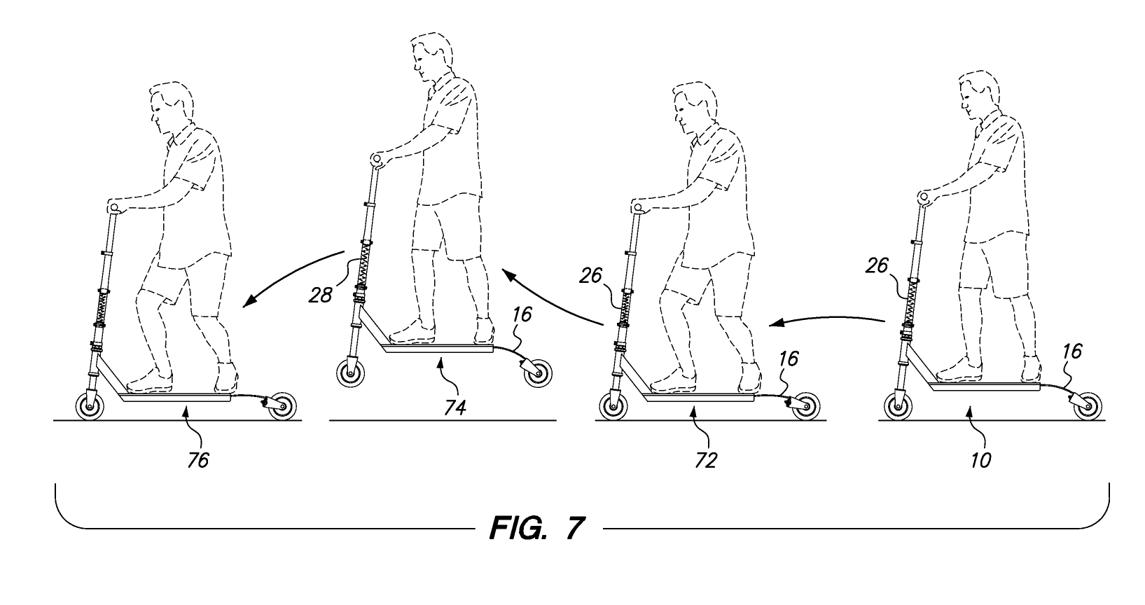

Referring to FIG. 7, the functioning of the front suspension and rear suspension is illustrated by showing a rider providing a downward force (right arrow) to the inventive push scooter 10 by directing his weight downward as shown by the scooter position 72. The suspension arm 16 of the scooter reacts by flexing downward and storing potential energy at position 72. The compression spring 26 of front suspension might also compress downward due to the applied downward force of the rider as is also seen at position 72. Next, scooter position 74 is caused by the rider shifting his weight upward by, in essence, jumping with the scooter. The stored potential energy stored in suspension arm 16 and compression spring 26 is released when the rider jumps, thus allowing the rider and scooter to leave the ground more easily (position 74) than standard push scooters. Upon scooter landing as shown by position 76, the compression spring 26 and suspension arm 16 compress and operate to cushion the impact upon the rider. If the rider wants to repeat the action multiple times, he can, with the front suspension acting like a pogo stick and the rear suspension continuing to flex with each downward-applied force.

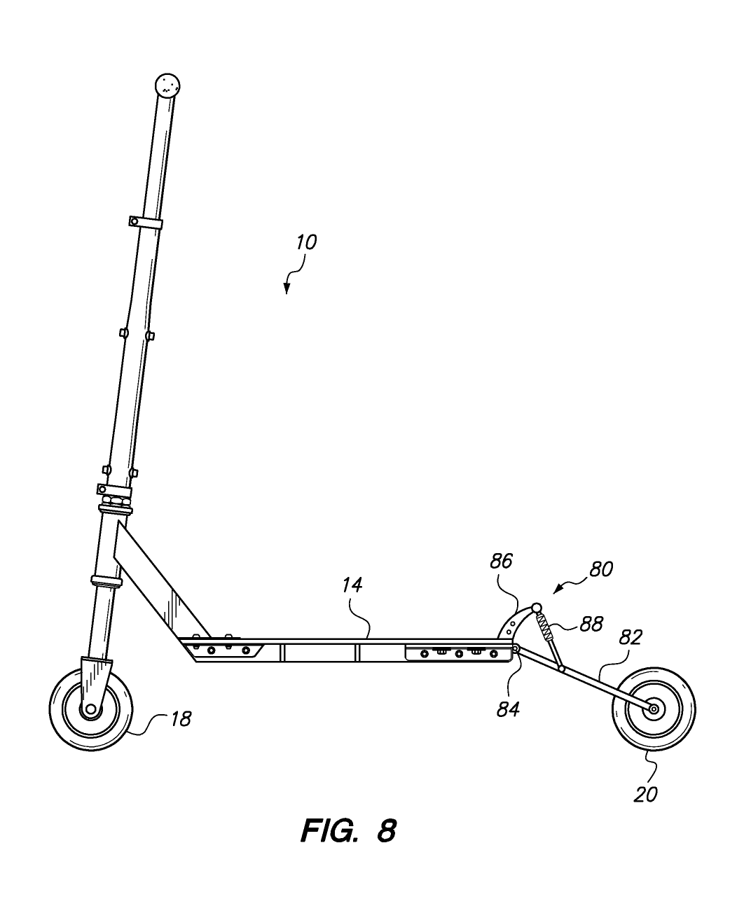

FIG. 8 is a side perspective view of an alternative embodiment 80 of the rear suspension for the inventive push scooter 10. A torsion arm 82 is pivotally attached to the rear of deck 14 at pivot point 84. Torsion arm 82 forms a fork (not shown) at its end opposite pivot point 84, wherein rear wheel 20 is attached to torsion arm 82. A mounting arm 86 is attached to the rear of the deck 14 and provides an attachment point for a shock absorber 88, which spans between mounting arm 86 and torsion arm 82. The shock absorber 88 holds the torsion arm 82 at a downwardly obtuse angle relative to the deck 14, and preferably between 100-130 degrees. When downward force is applied to the push scooter 10 by a rider, the torsion arm 82 pivots upward and stores potential energy in the shock absorber 88. When the rider jumps upward, the potential energy in the shock absorber 88 is released and transferred as downward force to the torsion arm 82. This action once again aids a rider in executing vertical acrobatic moves with the push scooter 10.

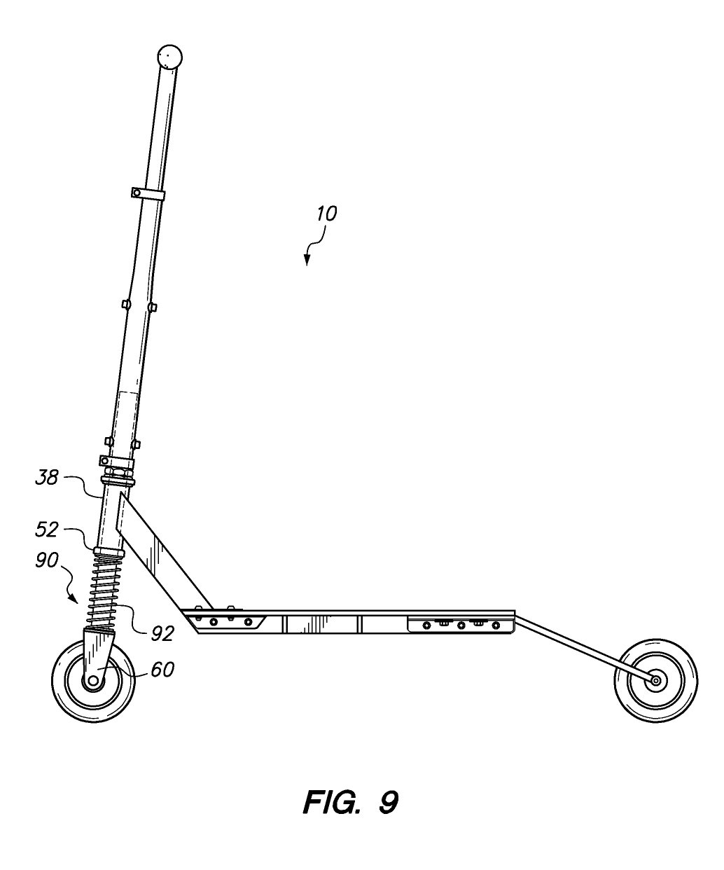

FIG. 9 illustrates an alternate embodiment 90 of the front suspension for the inventive push scooter 10. In this embodiment, the compression spring 92 is an external spring and is not contained in the shock tube 30 as previously described with compression spring 26. Here compression spring 92 surrounds the bottom of front suspension piston 48. Compression spring 92 is attached to the bottom end 52 of head tube 38 and to front wheel assembly 60.

Finally, although the description above contains much specificity, this should not be construed as limiting the scope of the invention, but as merely providing illustrations of some of the presently preferred embodiments of this invention. This invention may be altered and rearranged in numerous ways by one skilled in the art without departing from the coverage of any patent claims, which are supported by this specification.

1. A push scooter comprising,
a deck;
a rear suspension being comprised of a sprung suspension arm connected to and extending rearward of said deck and connecting to a rear wheel, said suspension arm flexing and storing potential energy upon receiving a downward-applied force.

2. The push scooter as recited in claim 1 further comprising a front suspension connected to a front of said deck, said front suspension being connected to a front wheel, said front suspension having approximately four inches of suspension travel.

3. The push scooter as recited in claim 2, wherein said front suspension further comprises an internal compression spring.

4. The push scooter as recited in claim 2, wherein said front suspension further comprises an external compression spring.

5. The push scooter as recited in claim 1, wherein said sprung suspension arm is a leaf spring.

6. A push scooter comprising,
a deck;
a steering assembly being attached to a front of said deck, said steering assembly incorporating a front shock absorbing suspension, said suspension being attached to a front wheel;
a rear suspension being attached between a rear wheel and a rear of said deck, said rear suspension being comprised of a sprung suspension arm, said suspension arm flexing and storing potential energy upon receiving a downward applied force, said suspension arm providing an upward lifting force when releasing its potential energy.

7. The push scooter as recited in claim 6, wherein said front shock absorbing suspension has up to four inches of suspension travel.

8. The push scooter as recited in claim 6, wherein said sprung suspension arm is a leaf spring.

9. The push scooter as recited in claim 6, wherein said front shock absorbing suspension is adjustable.

10. A push scooter comprising,
a deck;
a steering assembly comprising:
(a) a handle bar having a vertical handle bar tube connected to a shock tube;
(b) a compression spring, said compression spring being retained at its top end in said shock tube by a retaining plug;
(c) said shock tube coupling to a head tube, said head tube being connected to said deck;
(d) a suspension piston, said piston being inserted through a bottom of said head tube and placed in operative contact with said compression spring; and
a rear suspension being attached between a rear wheel and a rear of said deck, said rear suspension being comprised of an elongate sprung suspension arm, said suspension arm flexing and storing potential energy upon receiving a downward applied force, said suspension arm providing an upward lifting force when releasing its potential energy.

11. The push scooter as recited in claim 8, further comprising a device for adjusting the spring tension on said compression spring.
